(19) United States
(12) Patent Application Publication
(10) Pub. No.: US 2003/0213387 A1
(43) Pub. Date: Nov. 20, 2003

(54) Offset printing press with multi-image plate cylinder

(75) Inventor: Howard Walter Hoff, Lee, NH (US)

Correspondence Address: DAVIDSON, DAVIDSON & KAPPEL, LLC, 485 SEVENTH AVENUE, 14TH FLOOR, NEW YORK, NY, 10018, US

(73) Assignee: Heidelberger Druckmaschinen AG, Heidelberg (DE)

(21) Appl. No.: 10/144,884

(22) Filed: May 14, 2002

(51) Int. Cl. B41F 7/02

(52) U.S. Cl. 101/217

(57) ABSTRACT

An offset printing press includes a plate cylinder having a plate cylinder circumference and a blanket cylinder having a blanket cylinder circumference, the plate cylinder circumference being in a N:1 relationship with the blanket cylinder circumference, N being 2 or greater. The large plate circumference area permits for various components to fit around the plate cylinder, while using small blankets.

### BACKGROUND OF THE INVENTION

The present invention relates generally to printing presses and more particularly to offset printing presses.

An offset lithographic printing press has a plate or image cylinder on which an image is provided, either through direct imaging on the cylinder or through attachment of a printing plate having the image to the plate cylinder.

Ink is applied to the plate cylinder, and adheres to the image areas. The adhered ink is then transferred to a blanket cylinder, and then to a material to be printed, for example paper.

U.S. application Ser. No. 2001/037737 discloses an offset printing unit with a plate (form) cylinder and a blanket (transfer) cylinder. The circumference of the blanket cylinder is at least twice as large as the circumference of the plate cylinder. As discussed therein, it is also known that a plate cylinder may be two-around, in other words that two separate plates are provided in the circumferential direction of the plate cylinder.

### SUMMARY OF THE INVENTION

Large-circumference blanket cylinders require large blankets. Storage of such large blankets can present problems in press areas, where space is limited. This is particularly so when the blankets are sleeve-shaped gapless blankets. With one-around plate cylinders, moreover, there is little space for plate changers or imaging devices or other processing devices, especially in lithographic presses where inking and dampening units occupy much of the space. Thus for plates being directly imaged at the plate cylinder, extra circumferential space is often desired.

An object of the present invention is to permit for more circumferential space at the plate cylinder while maintaining small blanket cylinders.

The present invention provides an offset printing press comprising: a plate cylinder having a plate cylinder circumference, and a blanket cylinder having a blanket cylinder circumference, the plate cylinder circumference being in a N:1 relationship with the blanket cylinder circumference, N being 2 or greater.

By providing a larger plate cylinder circumference, direct imaging, plate changing and other processing devices, for example inking and dampening units, can fit around the circumference of the plate cylinder, while the blankets may remain small.

Preferably, N is 2.

The plate cylinder preferably includes a first removable plate and second removable plate circumferentially-spaced with respect to the first removable plate. The plate cylinder preferably has an axial and circumferential register mechanism to adjust the position of the first plate with respect to the position of the second plate.

During offset printing, some ink may remain on the blanket. Thus, it is preferable that the plate cylinder contains two duplicate images around its circumference. The second plate image than transfers ink to the blanket in the same location as the first plate image.

Alternately, full release inks and blankets that do not leave any residue on the blanket may be used. The circumferentially-spaced plates may then contain different images, since all the ink from the blanket is removed each revolution.

Preferably, the printing press includes a plate changer for providing blank printing plates to the plate cylinder and a direct imaging unit for imaging the blank printing plates.

The blanket cylinder of the present invention preferably includes an axially-removable cylindrical printing blanket, for example as disclosed in U.S. Pat. No. 5,440,981, which is hereby incorporated by reference herein.

An inking unit preferably is provided for inking the plate cylinder.

The present invention also provides a device for offset printing comprising: a plate cylinder having a plate cylinder circumference, and a blanket cylinder having a blanket cylinder circumference, the plate cylinder circumference being in a N:1 relationship with the blanket cylinder circumference, N being 2 or greater.

The device preferably is part of a print unit for a lithographic offset printing press.

### BRIEF DESCRIPTION OF THE DRAWINGS

The following figures show a preferred embodiment of the present invention in which:

FIG. 1 shows a schematic side view of a four-color offset web printing press according to the present invention; and

FIG. 2 shows a more detailed view of a printing unit of the printing press of FIG. 1.

### DETAILED DESCRIPTION OF A PREFERRED EMBODIMENT

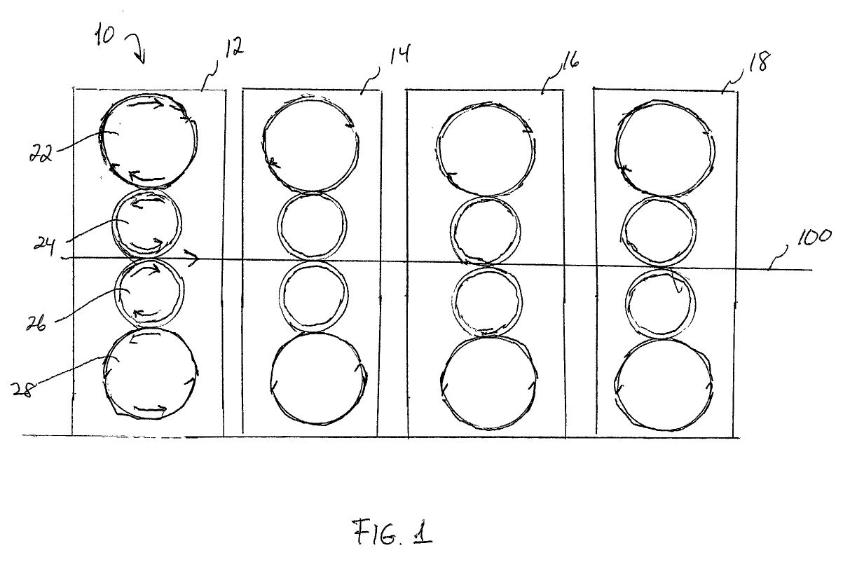

FIG. 1 shows a preferred exemplary embodiment of four-color lithographic web offset printing press 10 according to the present invention. Printing press 10 has four print units 12, 14, 16, 18, each for printing one color of an image, for example cyan, magenta, yellow and black. Each print unit has a two-around upper plate cylinder 22, a one-around upper blanket cylinder 24, a lower two-around plate cylinder 28, and a lower one-around blanket cylinder 26. Web 100 passes between blanket cylinders 24 and 26.

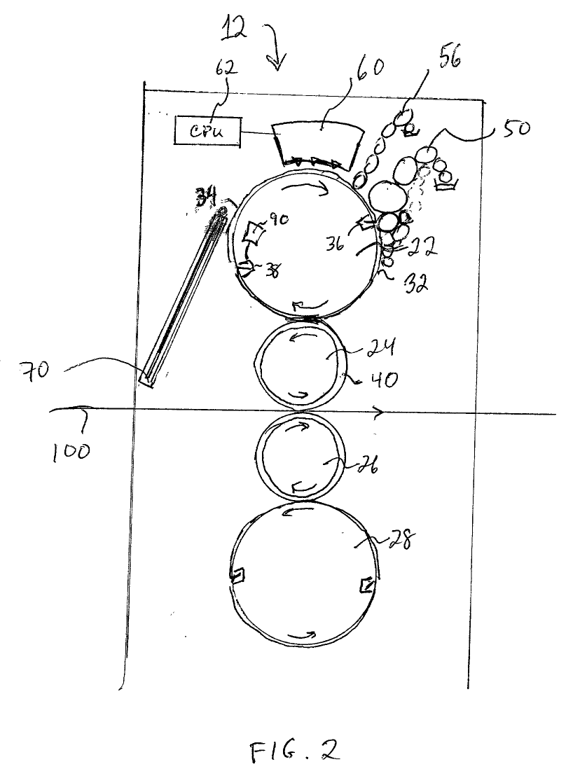

FIG. 2 shows one of the print units 12 in more detail. Plate cylinder 22 has a first printing plate 32 fastened to the plate cylinder body by a lock-up device 38, and a second, circumferentially-spaced printing plate 34 fastened to the plate cylinder body by a lock-up device 36. Plate cylinder 22 thus is a two-around plate cylinder, i.e. supports two images circumferentially.

Printing plates, including plates 34, 32, are provided by an automatic plate changer 70, for example a magazine-cartridge plate changer, which provides blank printing plates to the plate cylinder 22. The plates 34, 32 are images by a direct imaging unit 60, connected to a processor 62. Processor 62 may access a database having stored images, which then may be written on the plates 34, 32, for example by a laser or lasers in imaging unit 60.

A dampening solution may be provided to the plates 34, 32 by a dampening unit 56. An inking unit 50 may provide ink to the plates 34, 32.

As can be seen, the two-around plate cylinder provides more circumferential space for the various components 50, 56, 60, 70.

Once the plates 32, 34 are inked, the image is transferred to blanket cylinder 24, which may have a blanket 40, for example a gapless blanket. The image is then transferred to web 100.

The lower half of print unit 12 has similar components as those at the upper half, for example a plate changer, imaging unit, dampening unit and inking unit.

The printing press 10 may be used so that plates 32, 34 each carry exactly the same image. Preferably, lock-up devices 36, 38 are movable with respect to one another about the circumference of plate cylinder 22 to provide proper circumferential register, and also axially. In other words, the image on plate 32 should be provided to the blanket at exactly the same location as the image on plate 34, and an axial and circumferential register mechanism 90 may be provided at plate cylinder 22 to adjust one of the lock-up devices 38, 36 to ensure that the images align.

Alternately, the plates 32, 34 may carry different images. However, full release inks and blankets should then be used so that all of the ink on the blanket is released to web 100 as the blanket contacts web 100.

While a 2:1 plate cylinder/blanket cylinder unit has been shown, a 4:2, 3:1 or any N:1 combination may be provided.

Moreover, while the present invention preferably is used with removable printing plates, the term “plate cylinder” as used herein is also applicable to directly writeable image cylinders without actual plates.

What is claimed is:

1. An offset printing press comprising:
a plate cylinder having a plate cylinder circumference, and
a blanket cylinder having a blanket cylinder circumference, the plate cylinder circumference being in a N:1 relationship with the blanket cylinder circumference, N being 2 or greater.

2. The printing press as recited in claim 1 wherein N is 2.

3. The printing press as recited in claim 1 wherein the plate cylinder includes a first removable plate and second removable plate circumferentially-spaced with respect to the first removable plate.

4. The printing press as recited in claim 3 wherein the plate cylinder includes a register mechanism to adjust the position of the first plate with respect to the position of the second plate.

5. The printing press as recited in claim 3 wherein the first and second removable plates carry a same image.

6. The printing press as recited in claim 3 wherein the first and second removable plates carry different images.

7. The printing press as recited in claim 1 further comprising a plate changer for providing printing plates to the plate cylinder.

8. The printing press as recited in claim 7 further comprising a direct imaging unit for imaging the printing plates.

9. The printing press as recited in claim 8 further comprising an inking and dampening units at the plate cylinder.

10. The printing press as recited in claim 1 further comprising an inking unit for inking the plate cylinder.

11. The printing press as recited in claim 1 wherein the blanket cylinder includes a sleeve-shaped blanket.

12. The printing press as recited in claim 1 further comprising a further blanket cylinder and a further plate cylinder.

13. A device for offset printing comprising:
a plate cylinder having a plate cylinder circumference, and
a blanket cylinder having a blanket cylinder circumference, the plate cylinder circumference being in a N:1 relationship with the blanket cylinder circumference, N being 2 or greater.
